(19) United States
(12) Patent Application Publication
(10) Pub. No.: US 2015/0352885 A1
(43) Pub. Date: Dec. 10, 2015

(54) Objets de vertu

(71) Applicant: Things3D Limited, Cheshire (GB)

(72) Inventors: Joseph Ying Sen Wee, Cheshire (GB); Christopher Ian Byatte, Cheshire (GB); Anthony David George Rhoades, Cheshire (GB); David Leslie McNeight, Cheshire (GB)

(21) Appl. No.: 14/485,880

(22) Filed: Sep. 15, 2014

(30) Foreign Application Priority Data
Jun. 4, 2014 (GB) 1409906.3

(51) Int. Cl. B42D 25/305; B42D 25/40; B42D 25/485; G06K 19/077

(52) U.S. Cl. CPC B42D 25/305; G06K 19/07749; B42D 25/40; B42D 25/485

(57) ABSTRACT

A 3D printed objet de vertu including an embedded secured value indication.

### FIELD OF THE INVENTION

This invention relates to objets de vertu.

### BACKGROUND OF THE INVENTION

An objet de vertu is an object that has a value on account of some artistic or material or aesthetic content, and, for present purposes at least, is not recognized legal tender such as a coin, currency note or bill of exchange. It may take many forms, but is usually a small to medium sized work of artistic merit of superior materials or craftsmanship that has no particular usefulness, or of which its usefulness is of secondary importance, such as, for example, a highly embellished candlestick holder, etui, or salt cellar.

While, historically, objets de vertu have been handcrafted, as by a silversmith or jeweller, they can nowadays be produced by 3D printing. 3D printers can produce high value and complex designs in more than one material with fine and intricate detail, and, while they can produce many copies of the same article, they are adapted to producing limited editions and can incorporate ID information as an anticounterfeiting measure. 3D printed artefacts can be sought after by collectors, and are collected not just for their artistic merit but also, as is the case with hand crafted such objects, as an investment.

### BRIEF DESCRIPTION OF THE INVENTION

The present invention provides a means of creating exchangeable-for-value or investable 3D printed objets de vertu.

The invention comprises a 3D printed objet de vertu including an embedded secured value indication.

A secured value indication is a value indication that cannot be changed without authorisation or easily counterfeited.

A 3D printed objet de vertu may have a three dimensional form, but may, of course, be a 3D printed two dimensional article such for example as a certificate.

An objet de vertu printed according to the invention may have a value solely on account of or in addition to the secured value indication.

The secure value indication may be in a national or regional currency (such as Pounds Sterling, Euros or US Dollars) or may be in a currency of a peer-to-peer open source payment system such as Bitcoin or a virtual currency such as is used in on-line games. Virtual currencies may have a real world value inasmuch as they can be traded for money or money's worth.

Of particular interest are artefacts associated with on-line games played on computers, smart phones or television, or virtual worlds. Three dimensional renderings of characters and artefacts appearing in such games or worlds are produced for award or for sale to players, aficionados or collectors, and, inasmuch as they have some artistic or artisan merit, and produced, perhaps, in precious or semi-precious materials, may be regarded as objets de vertu.

Such artefacts may be awarded to or purchased by a player on attaining a particular level of achievement in an on-line game or in a virtual world. Artefacts corresponding to different levels of achievement may have different values. 3D printing is an accepted way of creating such artefacts. According to the invention, such 3D printed artefacts can have a secured value indication embedded during the printing.

The secured value indication may be machine readable, such, for example, as an RFID chip, embedded during 3D printing, or at least embedded after printing in tamper-proof fashion, with a value indication stored in a register that may be read by interrogating the chip so that it emits a signal including the value. The register may be a read only register, the contents of which cannot be changed, or it may be a read/write register the contents of which can be overwritten so that the value may be increased or decreased. Provisions will be in place, according to the invention, to ensure that this can only be done under authorisation.

Increase or decrease of the value indication may be effected for a variety of reasons. For example, in the case of an award for an on-line game, the value may be increased when another, higher, level is reached. Or an increase or decrease might be registered to reflect investment in or withdrawal from an account, or to reflect an interest or bonus payment.

The value indication may be produced by the printing process. Contrasting material can be printed as an alphanumeric code, a barcode, a QRC code or any other visually or machine readable code, and may be printed on a single printed layer or distributed between multiple layers to constitute a 3D code, which may only make sense when viewed from a particular direction or When integrated from multiple images. The contrasting material may comprise material of a different colour or material which is differently responsive to electromagnetic radiation of different wavelengths, which may be outwith the optical spectrum such as infra-red, ultra-violet or microwave, and which is thus not apparent unless appropriately illuminated. Such codes are not usually changeable.

For such value indication, the printing instruction may be built into the print file. For a limited multiple product licence, the file may contain a counter function that, when all the permitted products have been made, renders the file inoperable. However, provision may be made for the file to be updated after payment of a licence renewal fee.

Value indication codes such as bar codes and QRC codes may be read and verified or otherwise by a suitably-apped smartphone or tablet computer, which facilitates value verification in the field, by a prospective purchaser, for example.

In addition to the value indication code, the objet de vertu may have a secure ID code used to secure the value indication. The ID code may be of the same kind as the value indication code, and may be incorporated with the value indication code or may be different and separate from it.

The value indication code may be readable only by a specially programmed app on a smart phone, and, where it is changeable, changeable only by such an app.

The invention also comprises a method for making an objet de vertu including an embedded secured value indication comprising 3D printing the object and embedding the value indication during the printing.

Where an embedded value indication is comprised in a device such as an RFID chip, it will be inserted into a partially printed object and printing continued to embed it. Or a chip location may be designed into the article into which the chip may be introduced an sealed in temper-proof fashion.

An embedded value indication may, however, be created by the printing process.

The objet de vertu may be printed from a print file derived from a curated source, the file including printing instruction controlling embedding the value indication. The print file may be produced from a software development kit that facilitates the inclusion of value indication embedding instruction.

The invention also comprises a print file for an objet de vertu including an embedded secured value indication, comprising printing instruction controlling embedding of the embedded value indication.

And the invention also comprises a software development kit adapted to facilitate production of a print file for printing an objet de vertu including an embedded secured value indication, comprising a facility for the inclusion of value indication embedding instruction.

### BRIEF DESCRIPTION OF THE DRAWINGS

Objets de vertu and methods for making the same and according to the invention will now be described with reference to the accompanying drawing, in which:

FIG. 1 depicts a three-dimensional objet de vertu including secured value indications, and a smart phone being used to read value indications therefrom;

FIG. 2 is a section through part of a two-dimensional objet de vertu;

FIG. 3 is a view on Arrow 3 of FIG. 2; and

FIG. 4 is a schematic of the printing procedure.

### DETAILED DESCRIPTION OF THE INVENTION

The drawings illustrate 3D printed objets de vertu 11 including embedded secured value indications 12.

A secured value indication 12 cannot be changed without authorisation or easily counterfeited.

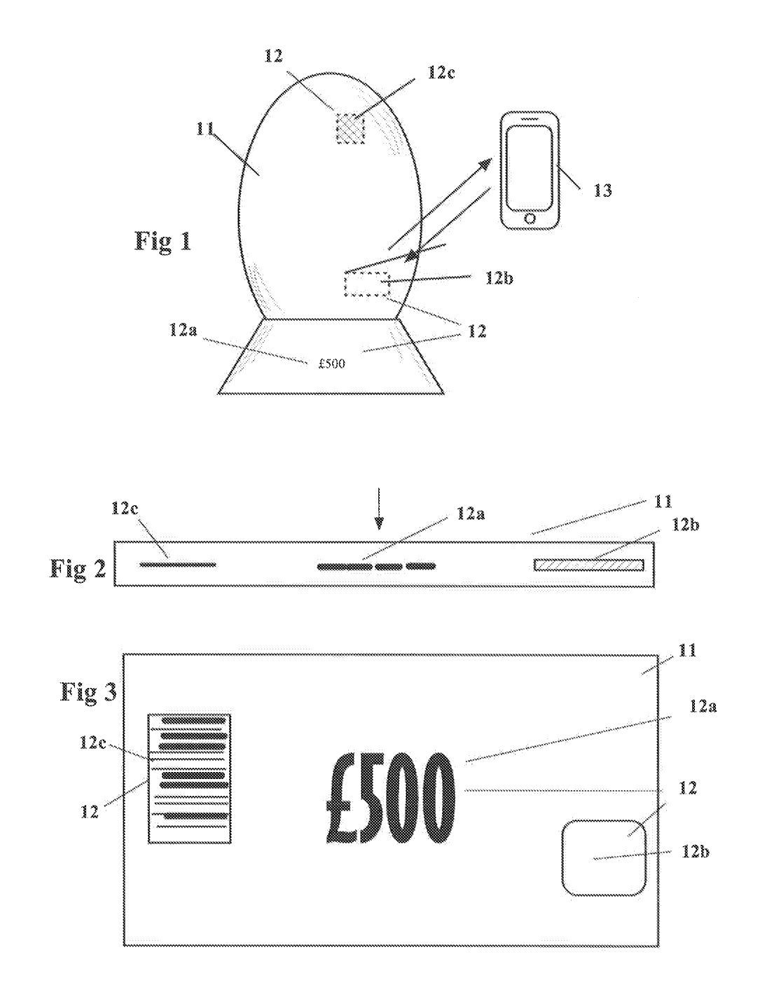

The 3D printed objet de vertu 11 of FIG. 1 has a three dimensional form, while that of FIGS. 2 and 3 is a 3D printed two dimensional article such for example as a certificate.

The embedded value indication 12 can simply be a visible currency value 12a, printed during printing one intermediate layer of the objet 11. It is therefore printed close to the surface of the objet or in a transparent part of the objet. With such a value indication, the objet may have a value solely on account of the secured value indication.

The secure value indication 12a is a value in Pounds Sterling currency, but could be in a national or regional currency such as Euros or US Dollars or in a currency of a peer-to-peer open source payment system such as Bitcoin or a virtual currency such as is used in on-line games. Virtual currencies may have a real world value inasmuch as they can be traded for money or money's worth. Coin of the realm is, of course, notoriously counterfeited—more than 3% of Pound Sterling coins in circulation are, according to the Royal Mint, counterfeit. Likewise banknotes are counterfeited, relying, as they do, on security printing, holograms and metal foil, all of which can, albeit at some cost, be reproduced well enough for the note to pass muster under all but expert scrutiny. Additional protection against counterfeiting could be given to higher value banknotes by regarding them as objets de vertu with secured value indications as taught herein.

The secured value indication 12 may be machine readable, such, for example, as an RFID chip 12b, embedded during or after 3D printing, so that it is tamper proof, with a value indication stored in a register that may be read by interrogating the chip so that it emits a signal including the value. The register may be a read only register, the contents of which cannot be changed, or it may be a read/write register the contents of which can be overwritten so that the value may be increased or decreased. Provisions will be in place, according to the invention, to ensure that this can only be done under authorisation.

A machine readable value indication may, however, be produced by the printing process. Contrasting material can be printed as an alphanumeric code, a barcode, a QRC code or any other visually or machine readable code 12c, and may be printed on a single printed layer or distributed between multiple layers to constitute a 3D code, which may only make sense when viewed from a particular direction or when integrated from multiple images. The contrasting material may comprise material of a different colour or material which is differently responsive to electromagnetic radiation of different wavelengths, which may be outwith the optical spectrum such as infra-red, ultra-violet or microwave, and which is thus not apparent unless appropriately illuminated. Such codes are not usually changeable, and will be secure on that account, but some embedded codes may be changeable as by involving an ink which may be bleached or colour-changed by a laser, or which might be created, and therefor changeable, by a laser creating micro-bubbles in a transparent plastic matrix, but which may only be correctly changed in a secure fashion as by a specially, and securely, programmed laser firing routine and/or a record of the change kept by a curating agency.

FIG. 1 shows a smartphone 13 being used to interrogate the RFID chip 12b by sending a coded power-up signal which inductively generates chip power (if the chip is passive) to cause it to radiate an ID/value signal and which may be used to change information stored in a register of the chip, for example to record an interrogation event or to change the value indication. A suitably-apped smartphone can also be used to read alphanumeric, bar, QRC and other coded information for ID and/or value confirmation.

Of particular interest are artefacts associated with on-line games played on computers, smart phones or television, or virtual worlds, and the object 11 of FIG. 1 could be one such, were it to be in the form of an artefact or character in such game or virtual world. Three dimensional renderings of characters and artefacts appearing in such games or worlds are produced for award or for sale to players, aficionados or collectors, and, inasmuch as they have some artistic or artisan merit, and produced, perhaps, in precious or semi-precious materials, may be regarded as objets de vertu, and ID-verified and value indication secured as taught herein.

Such artefacts 11 may be awarded to a player on attaining a particular level of achievement in an on-line game or in a virtual world. Artefacts corresponding to different levels of achievement may have different values. 3D printing is an accepted way of creating such artefacts. According to the invention, such 3D printed artefacts can have a secured value indication embedded during the printing.

Production of such artefacts may be entrusted to a 3D printing company or even to a participant in a game or virtual world who is in possession of or has access to a 3D printer, and this is facilitated by making available a print file that may include instructions for printing the value indication or, where the value indication is contained

Increase or decrease of the value indication may be effected for a variety of reasons. For example, in the case of an award for an on-line game, the value may be increased when another, higher, level is reached. Or an increase or decrease might be registered to reflect investment in or withdrawal from an account, or to reflect an interest or bonus payment.

For such value indication, the printing instruction may be built into the print file. For a limited multiple product licence, the file may contain a counter function that, when all the permitted products have been made, renders the file inoperable. However, provision may be made for the file to be updated after payment of a licence renewal fee.

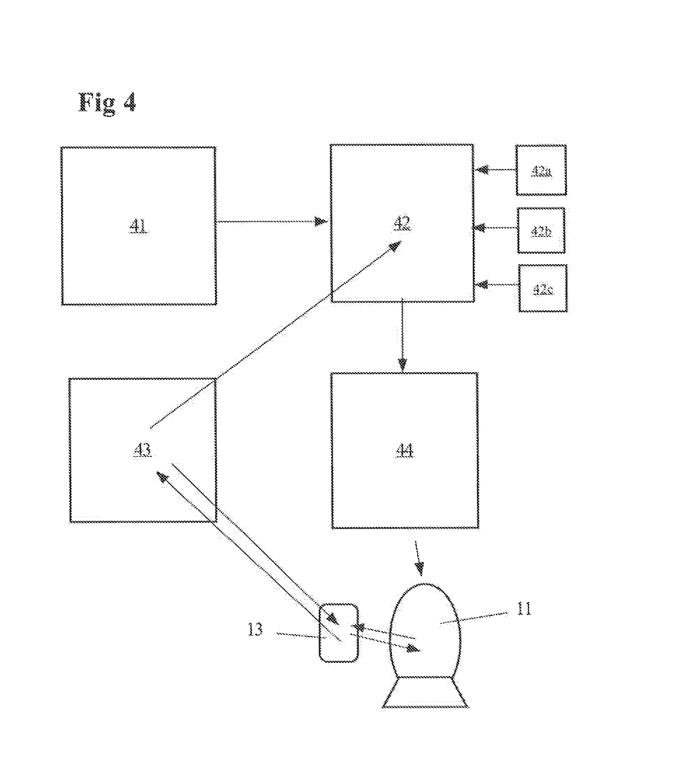

FIG. 4 illustrates how the objet de vertu 11 is printed by 3D printer 44 from a print file 42 of which at least the embedded value indication is derived from a curated source 43, the file 42 including printing instruction controlling embedding the value indication. The print file 42 is produced using a software development kit 41 that facilitates the inclusion of value indication embedding instruction. Additional inputs 42a, 42b, 42c contribute printing instruction modules for the shape, size, materials and other characteristics of the object.

The curated source 43 receives input from the smartphone 13 when it interrogates the RFID chip or other embedded value indication and performs appropriate ID and value verification which it sends back to the smartphone 13.

What is claimed:

1. A 3D printed objet de vertu including an embedded secured value indication.

2. An objet according to claim 1, having a three dimensional form.

3. An object according to claim 1, being a 3D printed two dimensional article such for example as a certificate.

4. An object according claim 1, having a value solely on account the secured value indication.

5. An object according to claim 1, having a value in addition to the secured value indication.

6. An object according to claim 1, in which the secure value indication is in a national or regional currency (such as Pounds Sterling, Euros or US Dollars).

7. An object according to claim 1, in which the secure value is in a currency of a peer-to-peer open source payment system such as Bitcoin or a virtual currency such as is used in on-line games.

8. An object according to claim 1, being an artefact associated with an on-line game played on computers, smart phones or television, or a virtual world.

9. An object according to claim 1, in which the secured value indication is machine readable, such, for example, as an RFID chip, embedded during or after 3D printing, with a value indication stored in a register that may be read by interrogating the chip so that it emits a signal including the value.

10. An object according to claim 9 in which the register is a read only register, the contents of which cannot be changed.

11. An object according to claim 9, in which the register a read/write register the contents of which can be overwritten so that the value may be increased or decreased.

12. An object according to claim 9, in which the value indication is produced by the printing process.

13. An object according to claim 12, in which contrasting material is printed as an alphanumeric code, a barcode, a QRC code or any other visually or machine readable code.

14. An object according to claim 11, in which the value indication printing instruction is built into the print file.

15. An object according to claim 12, in which a secure ID code is included which can be used to secure the value indication.

16. An object according to claim 15, in which the ID code is of the same kind as the value indication code.

17. A method for making an objet de vertu including an embedded secured value indication comprising 3D printing the object and embedding the value indication during or alter the printing.

18. A method according to claim 17, in which an embedded value indication is comprised in a device such as an RFID chip that is inserted into a partially printed object and printing continued to embed it or inserted after printing in tamper proof fashion.

19. A method according to claim 17, in which an embedded value indication is created by the printing process.

20. A method according claim 17, in which the objet de vertu is printed from a print file derived from a curated source, the file including printing instruction controlling embedding the value indication.

21. A method according to claim 20, in which the print file is produced from a software development kit that facilitates the inclusion of value indication embedding instruction.

22. A print file for an objet de vertu including an embedded secured value indication, comprising printing instruction controlling embedding of the embedded value indication.

23. A software development kit adapted to facilitate production of a print file for printing an objet de vertu including an embedded secured value indication, comprising a facility for the inclusion of value indication embedding instruction.
